(19) United States
(12) Patent Application Publication
(10) Pub. No.: US 2006/0041708 A1
(43) Pub. Date: Feb. 23, 2006

(54) Integrated circuit

(75) Inventor: Thomas Kunemund, Munich (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 11/181,033

(22) Filed: Jul. 12, 2005

(30) Foreign Application Priority Data
Aug. 3, 2004 (DE) 10 2004037 590.9

(51) Int. Cl. G06F 12/14

(52) U.S. Cl. 711/100

(57) ABSTRACT

Integrated circuit having an intermediate memory area, which has a first part designed to store a data word as an original, and has an at least second part designed to store the data word as a duplicate, and a comparison unit, which is designed to output an alarm signal if the original data word and the at least one duplicate data word do not match.

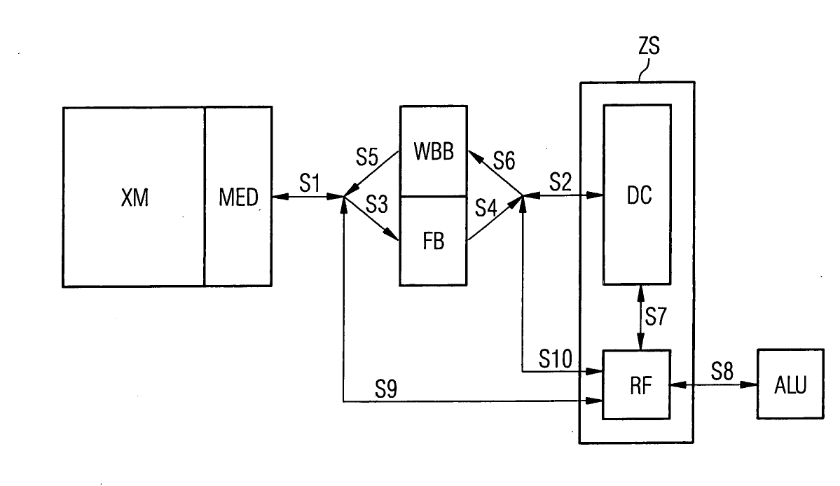

### CROSS-REFERENCE TO RELATED APPLICATION

This application claims priority to German Patent Application Serial No. 10 2004 037 590.9, which was filed on Aug. 3, 2004, and is incorporated herein by reference in its entirety.

### FIELD OF THE INVENTION

The invention relates to an integrated circuit and a method for operating such an integrated circuit.

### BACKGROUND OF THE INVENTION

Integrated circuits for security-relevant applications are often a target of attacks that aim to alter individual or a plurality of bits of confidential information. These alterations occur as a consequence of ionized radiation or laser radiation that can be used for an attack. Furthermore random bit errors also occur on account of natural radioactivity or cosmic secondary or tertiary radiation.

An integrated circuit essentially comprises a main memory, in which the data are present, an intermediate memory, which serves for providing the data during processing, and an arithmetic logic unit for processing the data.

Static random access memories, also referred to as SRAMs are particularly susceptible to bit errors on account of the effect of radiation. Static random access memories are used to provide data for processing within an integrated circuit. This provision is effected by means of a register bank accessed by the actual processor. In order to increase the performance of the overall system, current processor architectures contain buffer memories, also referred to as cache memories. Buffer memories are smaller than a main memory and permit faster access than the slow main memory. These radiation-sensitive circuit areas can be protected in hardware terms by radiation sensors. This method is expensive and complicated with regard to the area to be protected.

A suitable technical programming measure for detecting an attack is multiple calculation of the entire algorithm or relevant parts thereof. An inequality of the results permits the conclusion to be drawn that an attack has been effected. This is time- and energy-consuming, on the one hand, and yields reproducibly incorrect results, on the other hand, if the attack is effected in the same or very similar manner during each calculation.

### SUMMARY OF THE INVENTION

An object of the invention consists of detecting alterations of sensitive data, present for use in the intermediate memory area, resulting from a possible attack.

The circuit according to the invention comprises an intermediate memory area, which has a first part designed to store a data word as an original, and has an at least second part designed to store the data word as a duplicate, and a comparison unit, which is designed to output an alarm signal if the original and the at least one duplicate do not match.

### BRIEF DESCRIPTION OF THE DRAWING

The invention is explained below on the basis of an exemplary embodiment with reference to the figure, which shows a block diagram of an integrated circuit.

### DETAILED DESCRIPTION OF PREFERRED EMBODIMENTS OF THE INVENTION

The circuit according to the invention comprises an intermediate memory area, which has a first part designed to store a data word as an original, and has an at least second part designed to store the data word as a duplicate, and a comparison unit, which is designed to output an alarm signal if the original and the at least one duplicate do not match.

In this case, the data word as original and duplicate need not necessarily be present in identical form. Rather, the duplicate may also be generated from the data word by an operation. By way of example, consideration is given to generating the duplicate by inversion of the data word or an EXCLUSIVE-OR combination of the data word with a fixed value. A rotation of the data word, which is also referred to as shifting is also conceivable.

The comparison unit is designed such that it checks whether the original and the duplicate match, which means that original and duplicate are combined with one another in accordance with the operation used. The checking with regard to matching also comprises, of course, the special case of the identity check if the original and duplicate are provided in the same way. If more than one duplicate is provided, it is also possible to generate the duplicates by means of different operations.

In a preferred refinement of the integrated circuit, the intermediate memory area is coupled between a main memory and an arithmetic logic unit.

Since a security-relevant application is involved, the data words are generally present in encrypted fashion in the main memory. In this case, the main memory comprises a cryptographic unit, which is designed to decrypt the data word during loading from the main memory and to encrypt it during storage in the main memory.

The arithmetic logic unit in which the data words are processed is expediently designed for carrying out the comparison of the original and the duplicate. In one development, the cryptographic unit may also be designed for carrying out the checking with regard to matching. In this way, the comparison may be effected directly prior to the storage of a data word in the main memory.

The intermediate memory area comprises at least one register bank which provides the data word to the arithmetic logic unit. Furthermore, the intermediate memory area may comprise an additional buffer memory, which is larger than the register bank and permits a fast access to a larger scope of intermediately stored data words.

One refinement of the integrated circuit comprises a first buffer connected just like a second buffer between the buffer memory and the main memory. The first buffer and the second buffer serve as a pipeline stage in order to carry out the loading from and the storage in the main memory. In this case, the first buffer is designed to load the data word into the buffer memory. The second buffer is designed to load the data word into the main memory.

The integrated circuit advantageously has a first data bus and a second data bus, which are designed to transfer a data word between the main memory and the intermediate memory area. The original and the duplicate can be loaded into the intermediate memory area on two different paths such that a locally concentrated attack does not have the same effect on the data word that is loaded via different data buses. This permits the data manipulation to be ascertained.

The second data bus may be configured in such a way that it is coupled directly to the register bank whilst bypassing the buffer memory or whilst bypassing the buffer memory and the first and second buffers. This refinement permits a fast loading via the second bus.

One further development of the integrated circuit has, for programming, an instruction set comprising an instruction for storing a data word as an original and as at least one duplicate in the intermediate memory area. An instruction is furthermore provided for loading in a protected operating mode such that, besides the original, at least one duplicate is also loaded into the intermediate memory area. A further instruction is provided for intermediate storage in the protected operating mode such that, besides the original, at least one duplicate is also stored in the intermediate memory area. This instruction is required in order that the intermediate results of data words that have been calculated in the arithmetic logic unit or altered are stored in the protected operating mode as well. A further instruction comprises storage in the main memory in the protected operating mode such that a comparison of the original and the at least one duplicate takes place prior to storage.

This object is achieved by means of a method for operating such an integrated circuit in which, in a protected operating mode, a data word is both provided once as an original at one location of an intermediate memory area, and is provided at least once as a duplicate at another location in the intermediate memory area, the original and the at least one duplicate are compared, and the functional sequence of the circuit is altered if the original and the at least one duplicate do not match.

In this case, too, matching does not necessarily mean identity since the duplicate can also be generated from the data word by an operation and does not have to be identical to the original. The comparison involves checking whether original and duplicate are combined with one another in a defined manner. In the simplest case, original and duplicate are identical.

The method according to the invention has the advantage that, through the provision of two operating modes, the additional outlay for safeguarding the data can be restricted to sensitive data. The temporal and hardware outlay as a result of the multiple loading and multiple storage is thus kept within limits.

In order to detect a temporally and locally delimited attack, the data word and the duplicate are loaded successively from the main memory. In an advantageous manner, the original is loaded via a first data bus and the duplicate via a second data bus. The temporal and local separation of the loading of original and duplicate may also encompass only a part of the path from the main memory to the intermediate memory. It is thus possible for the second data bus to provide an alternative path between the first buffer and the register bank or an alternative path between the cryptographic unit and the register bank. It is likewise possible for the data word to be loaded into the first buffer and to be loaded therefrom multiply as original and duplicate into the intermediate memory area.

In one further development of the method, both the original and the duplicate are stored in the buffer memory and not until prior to the actual use in the arithmetic logic unit are they successively loaded into the register bank before the comparison takes place. As an alternative, the duplicate may also be loaded directly into the register bank, and the original is stored in the buffer memory before it is loaded into the register bank directly prior to the comparison.

In an advantageous manner, the comparison takes place directly before or after the use of the data word in the arithmetic logic unit in order to preclude a manipulation during the actual use of the sensitive data word.

A simple method for the identity check is an EXCLUSIVE-OR operation of original and duplicate.

The integrated circuit comprises a main memory XM comprising a cryptographic unit MED. Furthermore, the integrated circuit comprises a first buffer FB, a second buffer WBB and an intermediate memory area ZS, which comprises a buffer memory DC and a register bank RF, and also an arithmetic logic unit ALU. The cryptographic unit MED is coupled to the first buffer FB and the second buffer WBB via a bus path S1, which splits into two bus paths S3 and S5. The first buffer FB and the second buffer WBB are coupled to the buffer memory DC via two bus paths S6 and S4, which are combined to form a bus path S2.

The buffer memory DC is connected via the bus path S7 to the register bank RF, which, for its part, is coupled to the arithmetic logic unit ALU by a bus path S8. The intermediate memory area ZS comprises the buffer memory DC and the register bank RF.

The totality of the bus paths described is designated as first bus, via which the data transfer proceeds in regular fashion.

A second data bus comprises in the figure, by way of example, the connection S9 running between the register bank RF and the branching point of the connection between the cryptographic unit MED and the first and second buffers FB and WBB. An alternative configuration of the second data bus comprises the connection S10 running between the branching point of the connection between first and second buffers FB and WBB and the buffer memory DC and the register bank RF. The integrated circuit may also be configured with more than two buses, as illustrated in the figure.

During operation, a data word is loaded from the main memory XM into the register bank RF, in which the arithmetic logic unit ALU can access data words directly for processing.

The data words are present in encrypted fashion in the main memory XM and are decrypted by means of the cryptographic unit MED before they are loaded via the first or second data bus.

In a regular operating mode, the data word is loaded into the intermediate memory area ZS via a first data bus. In accordance with the figure, the loading process is effected via the bus paths S1 and S3 from the cryptographic unit MED of the main memory XM into the first buffer FB. The first buffer FB serves as a pipeline stage in order to load the data word via the bus paths S4 and S2 into the buffer memory DC. From there a data word is provided for processing via the bus path S7 in a register bank RF, which is accessed by the arithmetic logic unit ALU via the bus path S8.

For processing the arithmetic logic unit ALU reads data words as input values for an operation to be carried out from the register bank RF and writes the operation results to the register bank RF again.

For intermediate storage up to the further processing or up to the storage in the main memory XM, the data word is loaded from the register bank RF into the buffer memory DC via the bus path S7.

For storage in the main memory XM, the data word is loaded via the bus paths S2 and S6 into a second buffer WBB and from there is loaded via the data paths S5 and S1 to the cryptographic unit MED of the main memory XM, in which it is encrypted prior to storage.

In a protected operating mode, the data word is present in multiple places in the intermediate memory area ZS. The data word is provided as an original and at least one duplicate in different parts of the intermediate memory area ZS in order to detect an attack that has possibly been effected on the basis of differences.

The differences between the protected operating mode in comparison with the regular operating mode are illustrated below.

The loading process in the protected operating mode differs from the loading process in the regular operating mode by virtue of the fact that the data word is loaded multiple times and is stored once as an original and at least once as a duplicate in the intermediate memory area ZS. The loading processes are advantageously effected successively in order to detect time-variable attacks. Furthermore, in accordance with the figure, at least one duplicate is loaded into the intermediate memory area ZS via a second data bus. In this way, locally delimited attacks have a different effect on the original and the at least one duplicate. In accordance with the figure, the duplicate can be loaded directly into the register bank RF along the bus paths S1 and S9 via the second bus. As an alternative, it can also be loaded into the first buffer FB via the bus paths S1, S3 and into the register bank via the further bus paths S4 and S10 whilst bypassing the buffer memory DC.

In a circuit having more than two buses, a bus may be assigned to each duplicate, or the bus may be assigned to a duplicate according to the random principle.

It is likewise possible to store the original until the use first of all in the buffer memory DC and to load the duplicate via the same path into the buffer memory DC directly afterward further into the register bank RF, in which it is provided until the comparison. It is also possible to store the original and the duplicate in different parts of the buffer memory DC.

The original and the duplicate do not have to be stored identically, but rather can also be converted into one another by an operation.

Prior to the actual use of the data word in the arithmetic logic unit ALU, the original and the duplicate are compared. For this purpose, it is appropriate to load the original and the duplicate into the register bank RF if this has not yet taken place beforehand. The comparison is carried out by the arithmetic logic unit ALU.

If original and duplicate were stored identically, one possibility for checking the identity of two data words is to combine them by means of an EXCLUSIVE-OR function. A further possibility is a subtraction function.

It is appropriate to carry out the comparison directly prior to the use of the data word in the arithmetic logic unit ALU or thereafter in order to ensure that the data word is correct during the use.

For the case where the original and the duplicate are not identical or not combined with one another in the expected manner, the functioning of the circuit alters. This alteration consists, in the simplest case, in outputting an alarm signal indicating the possible attack. The circuit reaction to the alarm signal may subsequently be the carrying out of different routines, for example a resetting of the circuit into a defined initial state, which is also referred to as a reset, or a shutdown of the circuit.

Of course, the method in the protected operating mode is not restricted to the provision of only one duplicate, rather it is also possible to provide a plurality of duplicates. If more than one duplicate is used, it is also possible, as a reaction to the alarm signal, to carry out a majority decision of the original present and the duplicates present in order to determine a probable data word.

The intermediate storage of data words that have been generated or altered by the arithmetic logic unit ALU is also effected in a similar manner to the loading in the protected operating mode. Original and duplicate may be distributed between the buffer memory DC and the register bank RF in the manner outlined previously.

The storage of data words in the protected operating mode in the main memory XM is effected by subjecting the data word to a comparison of original and duplicate prior to storage. This comparison may be carried out as long as original and duplicate are still present in the intermediate memory area ZS, or the original and the duplicate are loaded into the second buffer WBB or into the cryptographic unit MED and the comparison is then carried out. The comparison may be carried out either by the arithmetic logic unit ALU or by the cryptographic unit MED, which has to be extended correspondingly in hardware terms for this purpose.

What is claimed is:

1. An integrated circuit comprising:
an intermediate memory area, which has a first part designed to store a data word as an original, and has an at least second part designed to store the data word as a duplicate; and
a comparison unit, which is designed to output an alarm signal if the original data word and the at least one duplicate data word do not match.

2. The integrated circuit as claimed in claim 1, further comprising:
a main memory; and
an arithmetic logic unit,
wherein the intermediate memory area is coupled between the main memory and the arithmetic logic unit.

3. The integrated circuit as claimed in claim 2, wherein the data word is present in encrypted fashion in the main memory, and the main memory comprises a cryptographic unit, which is designed to decrypt the data word after loading from the main memory and to encrypt the data word prior to storage in the main memory.

4. The integrated circuit as claimed in claim 3, wherein the arithmetic logic unit and/or the cryptographic unit are designed as the comparison unit.

5. The integrated circuit as claimed in claim 2, wherein the intermediate memory area comprises a register bank.

6. The integrated circuit as claimed in claim 5, wherein the intermediate memory area comprises a buffer memory coupled to the arithmetic logic unit via the register bank.

7. The integrated circuit as claimed in claim 2, further comprising:
a first buffer, which is coupled between the intermediate memory area and the main memory, and is designed to intermediately store the data word during loading from the main memory into the intermediate memory area; and
a second buffer, which is coupled between the intermediate memory area and the main memory, and is designed to intermediately store the data word during loading from the intermediate memory area into the main memory.

8. The integrated circuit as claimed in claim 6, further comprising a first path and a second path formed between the main memory and the intermediate memory area such that the data word can be transferred.

9. The integrated circuit as claimed in claim 8, wherein the first path is designed such that the main memory is coupled to the register bank via the buffer memory, and the second path is designed such that the buffer memory or the buffer memory and the first and second buffers is/are bypassed.

10. The integrated circuit as claimed in claim 1, wherein in a protected operating mode an instruction set provides an instruction for loading such that, besides the original data word, at least one duplicate data word is also loaded into the intermediate memory area.

11. The integrated circuit as claimed in claim 1, wherein in a protected operating mode an instruction set provides an instruction for intermediate storage such that, besides the original data word, at least one duplicate data word is also stored in the intermediate memory area.

12. The integrated circuit as claimed in claim 2, wherein in a protected operating mode an instruction set provides an instruction for storage in the main memory such that a comparison of the original data word and the at least one duplicate data word is carried out prior to storage of the data word.

13. A method for operating an integrated circuit, in a protected operating mode, comprising the steps of:
providing a data word once as an original data word at one location of an intermediate memory area, and at least once as a duplicate data word at another location in the intermediate memory area;
comparing the original data word and the at least one duplicate data word; and
altering a functional sequence of the circuit if the original data word and the at least one duplicate data word do not match.

14. The method as claimed in claim 14, wherein the original data word and the duplicate data word are identical.

15. The method as claimed in claim 13, wherein, for processing of the data word, it is possible to effect a changeover between the protected and a regular operating mode, in which the data word is provided at one location of the intermediate memory area.

16. The method as claimed in claim 13, wherein the original data word and the at least one duplicate data word are loaded prior to provision from a main memory.

17. The method as claimed in claim 16, further comprising the steps of:
loading the data word into a part of the integrated circuit that is coupled between a register bank and the main memory and is designed for intermediate storage; and
loading, from this part, the original data word and the at least one duplicate data word for the provision.

18. The method as claimed in claim 16, wherein the loading of the original data word and the at least one loading of the duplicate data word are effected successively.

19. The method as claimed in claim 16, wherein the loading of the original data word is effected via a first path and the loading of at least one duplicate data word is effected via a second path.

20. The method as claimed in claim 13, further comprising the step of loading the original data word and the at least one duplicate data word into a register bank for comparison.

21. The method as claimed in claim 13, further comprising the step of, in the protected operating mode and directly before and/or after use of the data word in an arithmetic logic unit, making a check to ascertain whether the original data word and the at least one duplicate data word match.

22. The method as claimed in claim 14, wherein the comparison of the original data word and the at least one duplicate data word is effected by an EXCLUSIVE-OR operation.

23. The method as claimed in claim 14, wherein the comparison of the original data word and the at least one duplicate data word is effected by a substraction operation.

24. An integrated circuit comprising:
an intermediate memory area, which has a first part designed to store a data word as an original, and has an at least second part designed to store the data word as a duplicate; and
a comparison means for outputting an alarm signal if the original data word and the at least one duplicate data word do not match.

25. The integrated circuit as claimed in claim 24, further comprising:
a main memory; and
an arithmetic logic unit,
wherein the intermediate memory area is coupled between the main memory and the arithmetic logic unit.

26. The integrated circuit as claimed in claim 25, wherein the data word is present in encrypted fashion in the main memory, and the main memory comprises a cryptographic means for decrypting the data word after loading from the main memory and for encrypting the data word prior to storage in the main memory.

27. The integrated circuit as claimed in claim 26, wherein the arithmetic logic unit and/or the cryptographic means are designed as the comparison means.

28. The integrated circuit as claimed in claim 25, wherein the intermediate memory area comprises a register bank.

29. The integrated circuit as claimed in claim 28, wherein the intermediate memory area comprises a buffer memory coupled to the arithmetic logic unit via the register bank.

30. The integrated circuit as claimed in claim 25, further comprising:
a first buffer means for intermediately storing the data word during loading from the main memory into the intermediate memory area; and
a second buffer means for intermediately storing the data word during loading from the intermediate memory area into the main memory,
wherein the first and second buffer means are coupled between the intermediate memory area and the main memory.

31. A computer program having a program code for performing a method for operating an integrated circuit, in a protected operating mode, comprising the steps of:
providing a data word once as an original data word at one location of an intermediate memory area, and at least once as a duplicate data word at another location in the intermediate memory area;
comparing the original data word and the at least one duplicate data word; and
altering a functional sequence of the circuit if the original data word and the at least one duplicate data word do not match,
when the computer program runs on a computer.

32. The computer program code of claim 31, wherein the method further comprises the steps of:
loading the data word into a part of the integrated circuit that is coupled between a register bank and a main memory and is designed for intermediate storage; and
loading, from this part, the original data word and the at least one duplicate data word for the provision.

33. The computer program code of claim 31, wherein the method further comprises the step of loading the original data word and the at least one duplicate data word into a register bank for comparison.

34. The computer program code of claim 31, wherein the method further comprises the step of, in the protected operating mode and directly before and/or after use of the data word in an arithmetic logic unit, making a check to ascertain whether the original data word and the at least one duplicate data word match.

35. A system for performing a method for operating an integrated circuit, in a protected operating mode, the system comprising:
a processor;
a memory communicatively coupled to the processor; and
software executing in the processor configured to:
a) provide a data word once as an original data word at one location of an intermediate memory area, and at least once as a duplicate data word at another location in the intermediate memory area;
b) compare the original data word and the at least one duplicate data word; and
c) alter a functional sequence of the circuit if the original data word and the at least one duplicate data word do not match.

36. The system of claim 33, wherein the software is further configured to:
d) load the data word into a part of the integrated circuit that is coupled between a register bank and a main memory and is designed for intermediate storage; and
e) load, from this part, the original data word and the at least one duplicate data word for the provision.

37. The system of claim 33, wherein the software is further configured to:
d) load the original data word and the at least one duplicate data word into a register bank for comparison.

38. The system of claim 33, wherein the software is further configured to:
d) in the protected operating mode and directly before and/or after use of the data word in an arithmetic logic unit, make a check to ascertain whether the original data word and the at least one duplicate data word match.
